(19) United States
(12) Patent Application Publication
(10) Pub. No.: US 2023/0391348 A1
(43) Pub. Date: Dec. 7, 2023

(54) METHOD AND APPARATUS FOR VEHICLE SPEED CORRECTION

(71) Applicant: HYUNDAI MOBIS CO., LTD., Seoul (KR)

(72) Inventors: Sung Hoon MOON, Yongin-si (KR); Hyo Chul KWAK, Hwaseong-si (KR)

(73) Assignee: HYUNDAI MOBIS CO., LTD., Seoul (KR)

(21) Appl. No.: 17/991,186

(22) Filed: Nov. 21, 2022

(30) Foreign Application Priority Data
Jun. 3, 2022 (KR) 10-2022-0068419

(51) Int. Cl. B60W 50/02; B60W 40/10; G01S 7/40

(52) U.S. Cl. CPC B60W 50/0225; B60W 40/10; G01S 7/40; B60W 2420/52; B60W 2554/20

(57) ABSTRACT

A method that is performed by an apparatus for vehicle velocity correction, the method comprising: a process of calculating a relative velocity of a stationary target detected by a first sensor included in a vehicle, and a relative angle between a driving direction of the vehicle and a direction in which the stationary target is positioned; a process of creating statistical data about a relative velocity ratio for a plurality of stationary targets based on the relative velocity ratio between a relative velocity of the stationary target and an ego-vehicle speed detected by a second sensor included in the vehicle; and a process of correcting the ego-vehicle speed detected by the second sensor based on a velocity ratio corresponding to a peak on the statistical data.

### CROSS-REFERENCE TO RELATED APPLICATIONS

This application is based on, and claims priority from, Korean Patent Application Number 10-2022-0068419, filed Jun. 3, 2022 in the Korean Intellectual Property Office, the disclosure of which is incorporated by reference herein in its entirety.

### TECHNICAL FIELD

The present disclosure relates to a method and apparatus for vehicle velocity correction.

### BACKGROUND

The following description simply provides only the background information related to the embodiment without configuring the related art.

Recently, it is tendency that a forward collision avoidance system for safety of a driver and passengers is obligatorily mounted in vehicles under rules in global vehicle market including the U.S. The forward collision avoidance system includes sensors such as a radar, a camera, or lidar. The radar sensor of these sensors is strong against changes of the natural environment including a weather condition and an optical condition such as inclement weather, so the radar sensor is generally used for vehicles.

The information of a target collected by a radar is expressed as relative numerals for a vehicle such as a relative velocity, a relative distance, and a relative angle. The vehicle estimates absolute numeral information of the target collected by the radar on the basis of information collected using other sensors in the vehicle such as a wheel velocity sensor and a yaw rate sensor.

However, since the wheel velocity sensor uses a method of indirectly measuring the velocity of a vehicle, the wheel velocity sensor has an error of the sensor itself. Further, an error may be generated in wheel velocity information due to deformation and an air pressure change of a tire. Incorrect wheel velocity sensor causes a problem that the velocity of a target detected by a radar is incorrectly estimated. Accordingly, in order to accurately estimate the velocity of a target detected by a radar, there is a need for a logic that compensates for an ego-vehicle speed by itself.

A vehicle velocity correction method of the related art compensates for an ego-vehicle speed detected by a wheel velocity sensor by detecting all stationary targets using a radar and calculating relative velocity distribution of the stationary targets.

However, the vehicle velocity correction method of the related art does not propose a solution for the case when an error is generated in a physical mounting angle of a radar. When an error is generated in the mounting angle of a radar in the process of assembling a vehicle or an error is generated in the physical mounting angle of a radar due to a traffic accident, the relative velocity distribution of stationary targets is distorted, so there is a problem that the ego-vehicle speed correction value is incorrect.

Further, ego-vehicle speed correction may be not operated well in a road environment in which a stationary target does not exist, and contrary, in a road environment in which a stationary target exist, a problem of performance deterioration of a radar is generated due to an increase of a calculation amount.

### SUMMARY

According to at least one embodiment, the present disclosure provides a method for vehicle velocity correction that is performed by an apparatus for vehicle velocity correction, the method comprising: a process of calculating a relative velocity of a stationary target detected by a first sensor included in a vehicle, and a relative angle between a driving direction of the vehicle and a direction in which the stationary target is positioned; a process of creating statistical data about a relative velocity ratio for a plurality of stationary targets on the basis of the velocity ratio between a relative velocity of the stationary target and an ego-vehicle speed detected by a second sensor included in the vehicle; and a process of correcting the ego-vehicle speed detected by the second sensor on the basis of a velocity ratio corresponding to a peak on the statistical data.

According to another embodiment, the present disclosure provides an apparatus for vehicle velocity correction, the apparatus comprising: a calculator calculating a relative velocity of a stationary target detected by a first sensor included in a vehicle, and a relative angle between a driving direction of the vehicle and a direction in which the stationary target is positioned; a statistics processor creating statistical data about a relative velocity ratio for a plurality of stationary targets on the basis of the velocity ratio between a relative velocity of the stationary target and an ego-vehicle speed detected by a second sensor included in the vehicle; and a vehicle speed corrector correcting the ego-vehicle speed detected by the second sensor on the basis of a velocity ratio corresponding to a peak on the statistical data.

According to yet another embodiment, the present disclosure provides a vehicle including an apparatus for vehicle velocity correction.

### BRIEF DESCRIPTION OF THE DRAWINGS

FIG. 1 is an exemplary view showing that an apparatus for vehicle velocity correction detects a plurality of stationary targets positioned at several angles with respect to a vehicle.

FIG. 2 is an exemplary view showing the ratio of a stationary target relative velocity and a vehicle velocity that changes in accordance with a relative angle on a graph.

FIG. 3 is a block diagram for describing each component that the apparatus for vehicle velocity correction according to an embodiment of the present disclosure includes.

FIG. 4 is an exemplary view showing a mathematical relationship between an ego-vehicle speed and the relative velocity of a stationary target.

FIG. 5 is an exemplary view showing a difference of a velocity ratio according to a mounting angle of a first sensor according to an embodiment of the present disclosure and an error of a detected ego-vehicle speed detection on a graph.

FIG. 6A-6B are exemplary views showing statistical data when there is no error of a second sensor and a first sensor according to an embodiment of the present disclosure.

FIG. 7A-7B are exemplary views showing statistical data when there is no error of the second sensor and an error by the first sensor exists.

FIGS. 8A-8B are exemplary views showing statistical data when an error by the second sensor exists and there is no error of the first sensor.

FIG. 9A-9B are exemplary views showing statistical data when errors by the second sensor and the first sensor exist.

FIG. 10A-10C are exemplary views showing controlling a transmission signal range of the first sensor.

FIG. 11 is a flowchart for describing each process included in a method of vehicle velocity correction that is performed by the apparatus for vehicle velocity correction according to an embodiment of the present disclosure.

FIG. 12 is a flowchart for describing each process included in a method of vehicle velocity correction that is performed by the apparatus for vehicle velocity correction according to an embodiment of the present disclosure and is based on accumulated differences of an ego-vehicle speed correction values.

FIG. 13 is a flowchart for describing each process included in a method of vehicle velocity correction that is performed by the apparatus for vehicle velocity correction according to an embodiment of the present disclosure and is based on control of a transmission signal range.

### DETAILED DESCRIPTION

An apparatus for vehicle velocity correction according to an embodiment can prevent distortion of ego-vehicle speed correction information when an error is generated in the physical mounting angle of a radar.

An apparatus for vehicle velocity correction according to another embodiment can correct an ego-vehicle speed even if ego-vehicle speed correction based on stationary target information is difficult in a road environment in which a stationary target does not exist.

An apparatus for vehicle velocity correction according to another embodiment can correct an ego-vehicle speed even without increasing the calculation amount of a radar in a road environment in which so many stationary targets exist.

Hereinafter, some embodiments of the present disclosure will be described in detail with reference to the accompanying drawings. In the following description, like reference numerals preferably designate like elements, although the elements are shown in different drawings. Further, in the following description of some embodiments, a detailed description of related known components and functions when considered to obscure the subject of the present disclosure will be omitted for the purpose of clarity and for brevity.

In describing the components of the embodiments, alphanumeric codes may be used such as first, second, i), ii), a), b), etc., solely for the purpose of differentiating one component from others but not to imply or suggest the substances, the order, or sequence of the components. Throughout this specification, when parts “include” or “comprise” a component, they are meant to further include other components, not to exclude thereof unless there is a particular description contrary thereto.

The description of the present disclosure to follow in conjunction with the accompanying drawings is intended to describe exemplary embodiments of the present disclosure and is not intended to represent the only embodiments in which the technical idea of the present disclosure may be practiced.

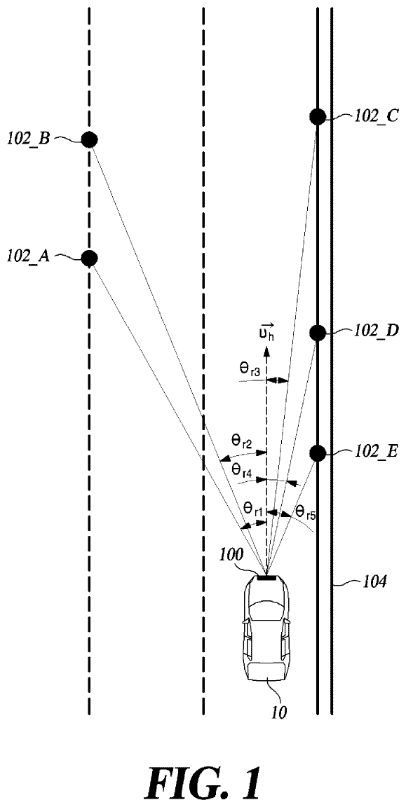

FIG. 1 is an exemplary view showing that an apparatus for vehicle velocity correction detects a plurality of stationary targets positioned at several angles with respect to a vehicle.

A vehicle velocity correction apparatus 100 included in a vehicle 10 senses a plurality of stationary targets 102 (102_A to 102_E) existing on a road using a first sensor (not shown). In this case, the first sensor may be a radar but the detailed kind of the first sensor is not limited thereto. The stationary target 102 may be a guar rail 104 or an object in a stop state positioned around the guard rail 104. In this case, a relative angle exists between a velocity vector of the vehicle 10 and a velocity vector of the stationary target with respect to the vehicle 10.

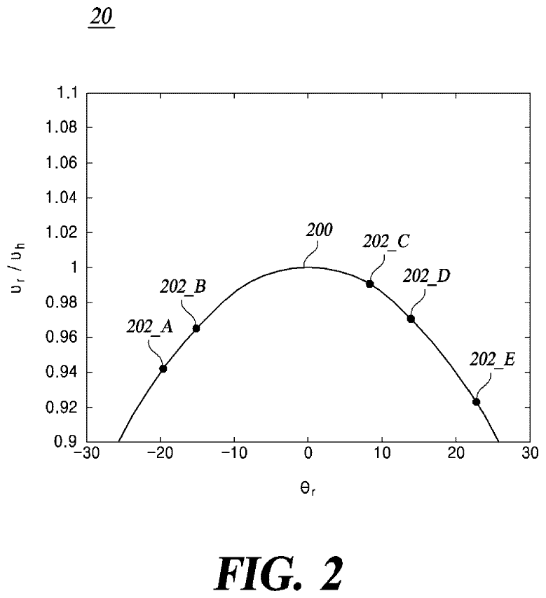

FIG. 2 is an exemplary view showing the ratio of a stationary target relative velocity and a vehicle velocity that changes in accordance with a relative angle on a graph.

Numerals of the relative velocity between the velocity vector of the vehicle 10 and a velocity vector of a stationary target are shown from −30 degrees to +30 degrees on the horizontal axis of a graph 20. A velocity ratio between the relative velocity of a stationary target and an ego-vehicle speed is shown from 0.9 to 1.1 with an interval of 0.02 on the vertical axis of the graph 20. The velocity ratio means the ratio between the relative velocity of a stationary target and an ego-vehicle speed in the present disclosure. A parabolic curve 200 is shown in the graph 20. The curve 200 shows the correlation between the relative velocity of a stationary target and the velocity ratio. When there is no error in a mounting angle of a first sensor, graph coordinates 202 (202_A to 202_E) corresponding to stationary targets, respectively, are positioned on the curve 200. The vehicle velocity correction apparatus 100 according to an embodiment of the present disclosure can correct an ego-vehicle speed regardless of whether an error is generated in the mounting angle of the first sensor using the characteristic that the ratio of the detected relative velocity of a stationary target and an ego-vehicle speed has predetermined correlation in accordance with a relative angle.

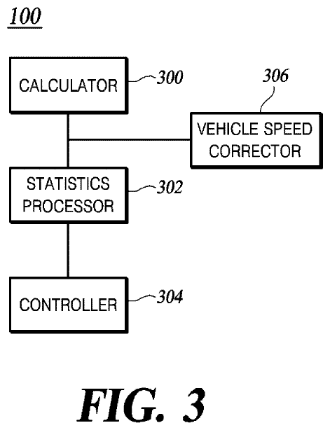

FIG. 3 is a block diagram for describing each component that the apparatus for vehicle velocity correction according to an embodiment of the present disclosure includes.

The vehicle velocity correction apparatus 100 according to an embodiment of the present disclosure includes all or some of a calculator 300, a statistics processor 302, a vehicle velocity corrector 304, and a controller 306. The vehicle velocity correction apparatus 100 shown in FIG. 3 is based on an embodiment of the present disclosure. All blocks shown in FIG. 3 are not necessary components, and in another embodiment, some blocks included in the vehicle velocity correction apparatus 100 may be added, changed, or removed. For example, the vehicle velocity correction apparatus 100 can perform ego-vehicle speed correction by operation of the calculator 300, the statistics processor 302, and the vehicle velocity corrector 304 except for the controller 306.

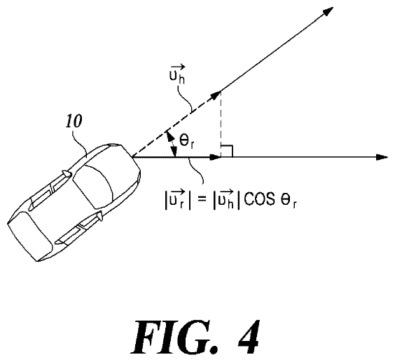

FIG. 4 is an exemplary view showing a mathematical relationship between an ego-vehicle speed and the relative velocity of a stationary target.

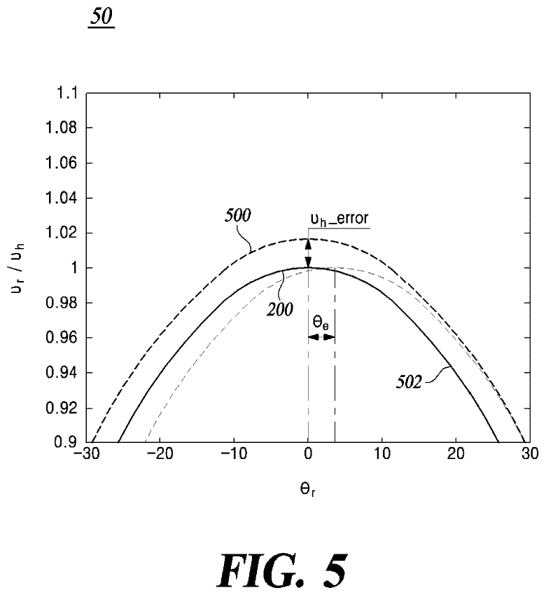

FIG. 5 is an exemplary view showing a difference of a velocity ratio according to a mounting angle of a first sensor according to an embodiment of the present disclosure and an error of a detected ego-vehicle speed detection on a graph.

Hereafter, each of components included in the vehicle velocity correction apparatus 100 is described with reference to FIGS. 3 to 5.

The calculator 300 calculates the relative velocity of a stationary target detected by the first sensor included in the vehicle 10, and the relative angle between the driving direction of the vehicle and the stationary target. In this case, the relative angle may be an angle made by a velocity vector of the vehicle and the velocity vector of the stationary target. The calculator 300 can calculate a velocity ratio between the relative velocity of a stationary target and an ego-vehicle speed using the relative velocity of the stationary target.

Referring to FIG. 4, the relative velocity vᵣ of a stationary target detected from a signal reflected by the stationary target is projection of the driving direction velocity of the vehicle vₕ with respect to the relative angle θ of the stationary target. That is, when the first sensor is a front radar, the relationship of Equation 1 is formed between the relative velocity vᵣ of a stationary target reflection signal and the ego-vehicle speed vₕ.

$$[ Equation 1 ]$$

$$- {v}_{r} = \vert \vec{{v}_{h}} \vert cos θ \qquad ( 1 a )$$

$$∴ \frac{- {v}_{r}}{{v}_{h}} = cos θ \qquad ( 1 b )$$

Meanwhile, when the first sensor is a rear radar, the relationship of Equation 2 is formed between the relative velocity vᵣ of a stationary target reflection signal and the ego-vehicle speed vₕ.

$$[ Equation 2 ]$$

$$+ {v}_{r} = \vert \vec{{v}_{h}} \vert cos θ \qquad ( 2 a )$$

$$∴ \frac{+ {v}_{r}}{{v}_{h}} = cos θ \qquad ( 2 b )$$

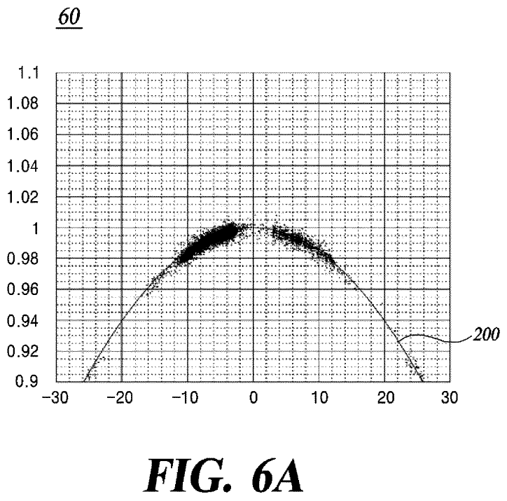

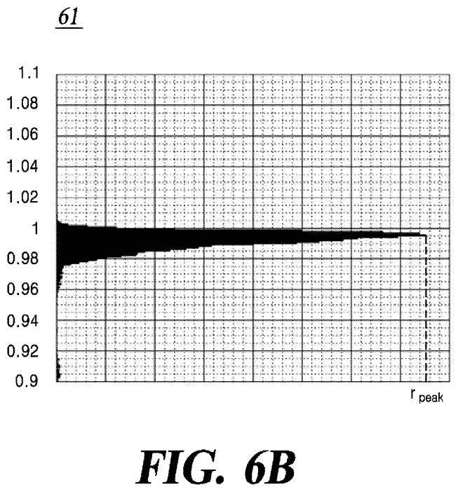

The statistics processor 302 creates statistical data about the velocity ratio for a plurality of stationary targets on the basis of the velocity ratio between the relative velocity of a stationary target and an ego-vehicle speed detected by a second sensor (not shown) included in the vehicle 10. The second sensor may be a wheel velocity sensor that estimates an ego-vehicle speed on the basis of a wheel velocity, but the detailed kind of the second sensor is not limited thereto. The statistics processor 302 collects statistics of the correlation between the relative velocity of a stationary target and an ego-vehicle speed using the characteristic that the possibility of a stationary target existing ahead of or behind the vehicle is low. In this case, the statistical data created by the statistics processor 302 may be a histogram in which the velocity ratios for stationary targets are accumulated. Statistical data of a histogram type will be described below with reference to FIGS. 6 to 9.

Referring to FIG. 5, a characteristic in which a velocity ratio changes in accordance with a mounting angle error of the first sensor and an ego-vehicle speed detection error of the second sensor is shown. The mounting angle error and the ego-vehicle speed detection error are as in Equation 3a and Equation 3b, respectively. In this case, θ_error means a mounting angle error and v_{h_error} means an ego-vehicle speed detection error.

[Equation 3]

cos(θ−θ_error) (3a)

v_{h_error}*cos θ (3b)

The vehicle velocity corrector 304 corrects an ego-vehicle speed detected by the second sensor on the basis of a velocity ratio corresponding to the peak of statistical data. In detail, the vehicle velocity corrector calculates a corrected ego-vehicle speed by multiplying a reciprocal of a velocity ratio corresponding to a peak by an ego-vehicle speed detected by the second sensor. The peak of a statistical data expressed in a histogram type is characterized by being positioned close to 1 when an ego-vehicle speed is correct and by coming out of 1 when an ego-vehicle speed is incorrect by a second sensor error. The vehicle velocity corrector 304 corrects an ego-vehicle speed using the characteristic that a velocity ratio changes in accordance with an error of the second sensor.

Meanwhile, when ego-vehicle speed correction values are calculated over a predetermined number of times of correction, the calculator 300 can calculate the accumulated difference of the accumulated ego-vehicle speed correction values. A reference number of times of correction that is the premise of calculation of accumulated difference may be changed in various ways in accordance with embodiments of the present disclosure.

When the calculated accumulated difference is less than a preset reference difference, the vehicle velocity corrector 304 determines the average of the accumulated ego-vehicle speed correction values as a final ego-vehicle speed correction value. A reference difference that is the premise for determining the final ego-vehicle speed correction value may be changed in various ways in accordance with embodiments of the present disclosure. When a plurality of ego-vehicle speed correction values with a small difference is accumulated, the vehicle velocity correction apparatus 100 determines the average of the ego-vehicle speed correction values as the final ego-vehicle speed correction value. Accordingly, there is an effect that the accuracy of the ego-vehicle speed correction value determined by the vehicle velocity correction apparatus 100 is improved.

FIG. 6A-6B are exemplary views showing statistical data when there is no error of a second sensor and a first sensor according to an embodiment of the present disclosure.

Referring to a graph 60 of FIG. 6A, statistical data expressed on a correlation graph 200 between a velocity ratio and a relative angle are shown. Since there is no error by the first sensor and the second sensor, most of the coordinates corresponding to a plurality of stationary targets are positioned on the curve 200.

Referring to statistical data 61 expressed in a histogram type of FIG. 6B, the peak of the vehicle velocity ratio is formed around 1. Accordingly, the vehicle velocity corrector 304 determines an ego-vehicle speed correction value by multiplying an ego-vehicle speed detected by the second sensor by 1 that is the reciprocal of the peek.

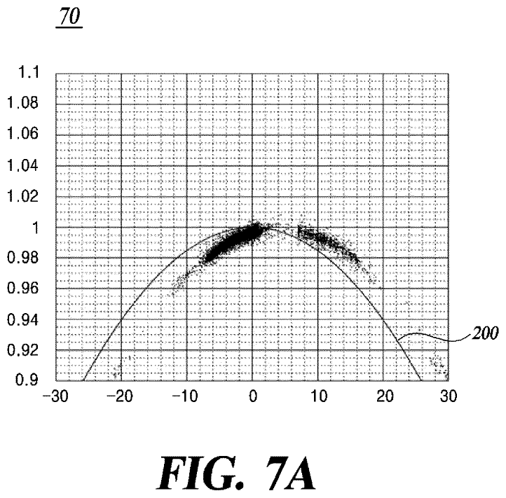

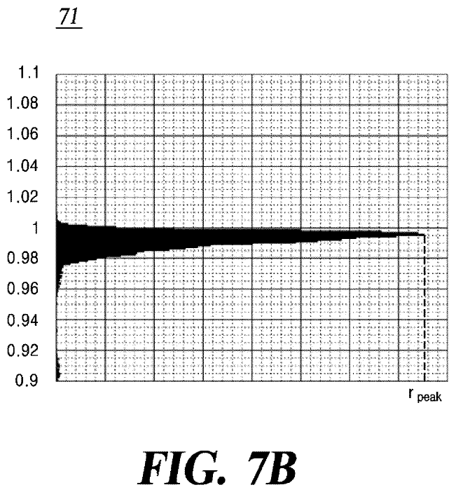

FIG. 7A-7B are exemplary views showing statistical data when there is no error of the second sensor and an error by the first sensor exists.

Referring to a graph 70 of FIG. 7A, statistical data in which a difference for a correlation graph 200 between a velocity ratio and a relative angle exists are shown. Since a mounting angle error of the first sensor exists, the statistical data are biased toward the horizontal axis.

However, referring to statistical data 71 expressed in a histogram type of FIG. 7B, the peak of the vehicle velocity ratio is formed around 1. Accordingly, the vehicle velocity corrector 304 determines an ego-vehicle speed correction value by multiplying an ego-vehicle speed detected by the second sensor by 1 that is the reciprocal of the peek. That is, there is an effect that the vehicle velocity correction apparatus 100 can determine an ego-vehicle speed correction value regardless of whether an error is generated in the mounting angle of the first sensor.

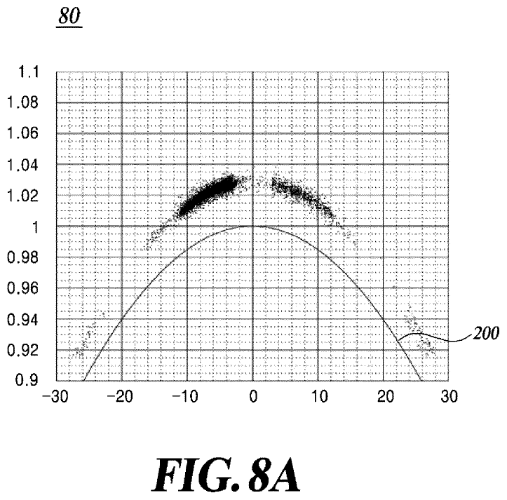

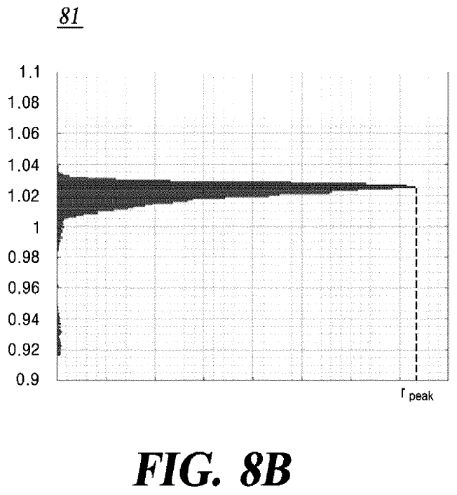

FIG. 8A-8B are exemplary views showing statistical data when an error by the second sensor exists and there is no error of the first sensor.

Referring to a graph 80 of FIG. 8A, statistical data in which a difference exists in the vertical axis direction with respect to a correlation graph 200 between a velocity ratio and a relative angle are shown. Since an ego-vehicle speed detection error of the second sensor exists, the statistical data are biased toward the vertical axis.

Referring to statistical data 81 expressed in a histogram type of FIG. 8B, the peak of the vehicle velocity ratio is formed around 1.02. Accordingly, the vehicle velocity corrector 304 determines an ego-vehicle speed correction value by multiplying an ego-vehicle speed detected by the second sensor by the reciprocal of the peak 1.02.

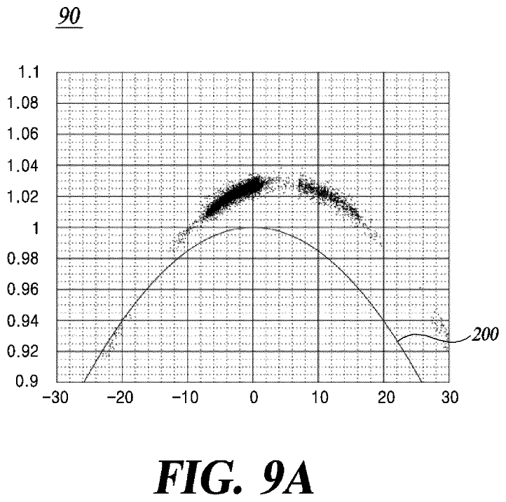

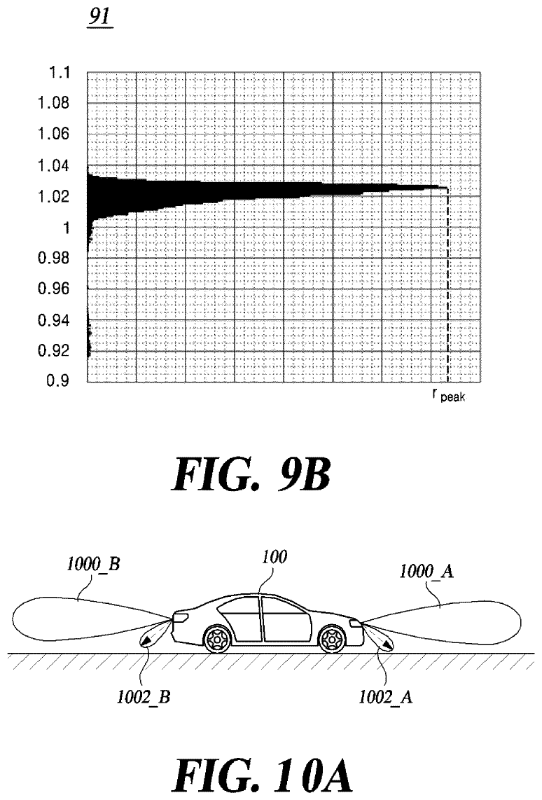

FIG. 9A-9B are exemplary views showing statistical data when errors by the second sensor and the first sensor exist.

Referring to a graph 90 of FIG. 9A, statistical data in which a difference exists in the horizontal axis direction and the vertical axis direction with respect to a correlation graph 200 between a velocity ratio and a relative angle are shown. Since an ego-vehicle speed detection error of the second sensor exists, the statistical data are biased toward the horizontal axis and the vertical axis.

Referring to statistical data 91 expressed in a histogram type of FIG. 9B, the peak of the vehicle velocity ratio is formed around 1.02. Accordingly, the vehicle velocity corrector 304 determines an ego-vehicle speed correction value by multiplying an ego-vehicle speed detected by the second sensor by the reciprocal of the peak 1.02. That is, comparing the embodiments of FIG. 8A-8B and FIG. 9A-9B, there is an effect that the vehicle velocity correction apparatus 100 can correct an ego-vehicle speed regardless of whether an error is generated in the mounting angle of the first sensor.

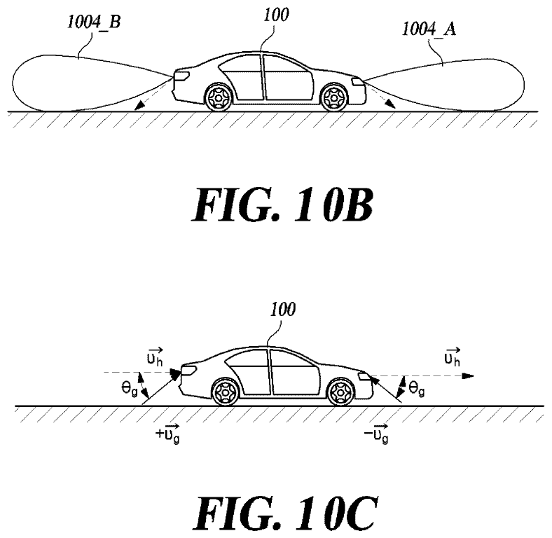

FIG. 10A-10C are exemplary views showing controlling a transmission signal range of the first sensor.

A vehicle velocity correction method based on stationary target information does not have a reference of ego-vehicle speed correction in a road environment in which a stationary target does not exist, so there is a problem that the method cannot perform ego-vehicle speed correction. Further, the vehicle velocity correction method based on stationary target information has a problem that the performance of the first sensor is deteriorated by an increase in a calculation amount in a road environment in which so many stationary targets exist.

The vehicle velocity correction apparatus 100 can correct an ego-vehicle speed by controlling a transmission signal range of the first sensor when the number of stationary targets is less than a first reference number of article or exceeds a second reference number of article. In this case, the first reference number of article and/or the second reference number of article may be changed in various ways in accordance with embodiments of the present disclosure. When the number of stationary targets is less than the first reference number of article or exceeds the second reference number of article, it may be referred to as an exceptional circumstance.

The controller 306 transmits a control signal for controlling the range of the transmission signal that is transmitted from the first sensor to the first sensor. In this case, the control signal that is transmitted to the first sensor from the controller 306 may be a control signal that makes the first sensor generate an additional transmission signal of a side-lobe type toward the ground. In another embodiment, the control signal may be a control signal that makes the first sensor generate a transmission signal having an expanded range toward the ground.

Referring to FIG. 10A, a transmission signal transmitted by the first sensor in accordance with operation of the controller 306 is visually expressed. When stationary targets exist by the first reference number or article or more and less than the second reference number or article, the controller 306 can control the first sensor to transmit a general transmission signal 1000 (1000_A and 1000_B). The controller 306, in this exceptional circumstance, can control the first sensor to generate an additional transmission signal 1002 (1002_A and 1002_B) of a side-lobe type toward the ground.

Referring to FIG. 10B, a transmission signal transmitted and expanded by the first sensor in accordance with operation of the controller 306 is visually expressed. The controller 306, in this exceptional circumstance, can control the first sensor to generate an expanded transmission signal 1004 (1004_A and 1004_B) toward the ground. The controller 306 may select a control signal to transmit to the first sensor such that the first sensor transmits the transmission signal of FIG. 10A or FIG. 10B in consideration of the driving environment of the vehicle and the driving state of the vehicle.

The calculator 300 calculates the relative angle and the relative velocity of a reflection signal reflected by the ground in response to the transmission signal generated by the first sensor in accordance with a control signal.

The vehicle velocity corrector 304 corrects an ego-vehicle speed detected by the second sensor on the basis of the relative angle and the relative velocity. Referring to FIG. 10C, the relative velocity v_{g} of the signal reflected by the ground is the same as the scalar product of the relative angle θ_{g} of the reflection signal and a vehicle driving direction velocity vₕ. That is, when the first sensor is a front radar, the driving direction velocity of the vehicle calculated by the vehicle velocity corrector 304 using a ground reflection signal is as in Equation 4.

$$[ Equation 4 ]$$

$$- {v}_{r} = \vert \vec{{v}_{h}} \vert cos {θ}_{g} \qquad ( 4 a )$$

$${v}_{h} = \frac{- {v}_{r}}{cos {θ}_{g}} \qquad ( 4 b )$$

Meanwhile, when the first sensor is a front radar, the driving direction velocity of the vehicle calculated by the vehicle velocity corrector 304 using a ground reflection signal is as in Equation 5. The vehicle velocity corrector 304 can calculate an ego-vehicle speed on the basis of the relationship of Equation 4 or Equation 5 even if the first sensor is a front-side radar or a rear-side radar. Accordingly, there is an effect that the vehicle velocity correction apparatus 100 makes it possible to correct and ego-vehicle speed even in an exceptional circumstance in which the number of stationary targets rapidly changes.

$$[ Equation 5 ]$$

$${v}_{r} = \vert \vec{{v}_{h}} \vert cos {θ}_{g} \qquad ( 5 a )$$

$${v}_{h} = \frac{+ {v}_{r}}{cos {θ}_{g}} \qquad ( 5 b )$$

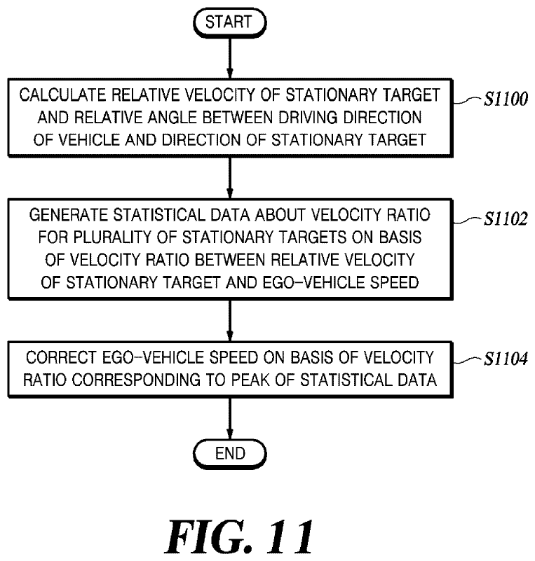

FIG. 11 is a flowchart for describing each process included in a method of vehicle velocity correction that is performed by the apparatus for vehicle velocity correction according to an embodiment of the present disclosure.

The vehicle velocity correction apparatus 100 calculates the relative velocity of a stationary target detected by the first sensor included in a vehicle, and the relative angle between the driving direction of the vehicle and the direction in which the stationary target is positioned (S1100).

The vehicle velocity correction apparatus 100 creates statistical data about the velocity ratio for a plurality of stationary targets on the basis of the velocity ratio between the relative velocity of a stationary target and an ego-vehicle speed detected by a second sensor included in the vehicle (S1102). In this case, the statistical data may be a histogram in which the velocity ratios of stationary targets are accumulated.

The vehicle velocity corrector 100 corrects an ego-vehicle speed detected by the second sensor on the basis of a velocity ratio corresponding to the peak of statistical data (S1104). The vehicle velocity corrector 100 can calculate a corrected ego-vehicle speed by multiplying the reciprocal of a velocity ratio corresponding to the peak of the statistical data by an ego-vehicle speed detected by the second sensor.

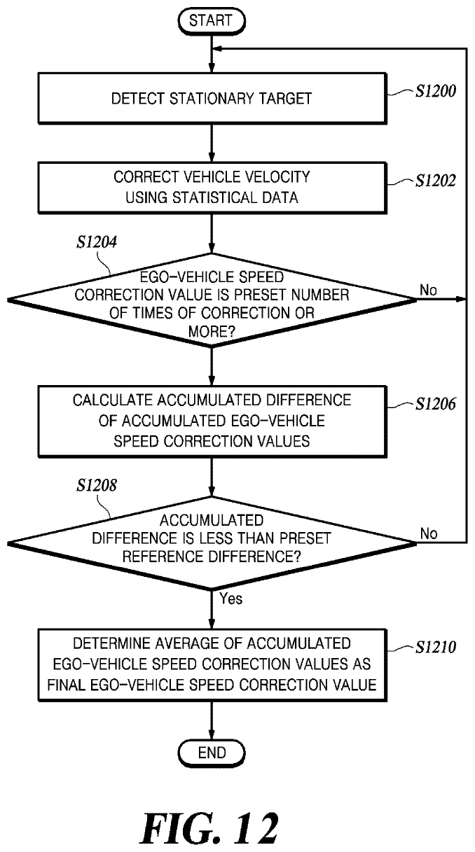

FIG. 12 is a flowchart for describing each process included in a method of vehicle velocity correction that is performed by the apparatus for vehicle velocity correction according to an embodiment of the present disclosure and is based on accumulated differences of an ego-vehicle speed correction values.

The vehicle velocity correction apparatus 100 detects a stationary target using the first sensor (S1200).

The vehicle velocity correction apparatus 100 corrects an ego-vehicle speed using statistical data calculated on the basis of a plurality of stationary targets (S1202). In this case, the process S1202 may include the processes S1100 to S1104 of FIG. 11.

When ego-vehicle speed correction value are calculated over a predetermined number of times of correction, the vehicle velocity correction apparatus 100 calculates the accumulated difference of the accumulated ego-vehicle speed correction values (S1204, S1206).

When the calculated accumulated difference is less than a preset reference difference, the vehicle velocity corrector 100 determines the average of the accumulated ego-vehicle speed correction values as a final ego-vehicle speed correction value (S1208, S1210).

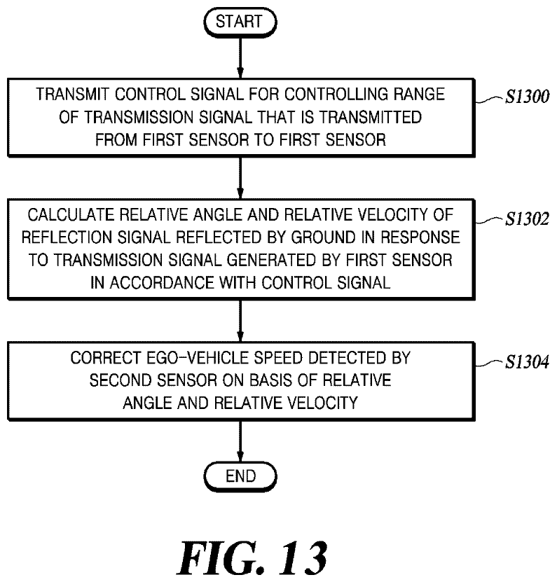

FIG. 13 is a flowchart for describing each process included in a method of vehicle velocity correction that is performed by the apparatus for vehicle velocity correction according to an embodiment of the present disclosure and is based on control of a transmission signal range.

The vehicle velocity correction apparatus 100 transmits a control signal for controlling the range of the transmission signal that is transmitted from the first sensor to the first sensor (S1300). In this case, the control signal may be a control signal making the first sensor generate an additional transmission signal in a side-lobe type toward the ground or a control signal making the first sensor generate a transmission signal having an expanded range toward the ground.

The vehicle velocity correction apparatus 100 calculates the relative angle and the relative velocity of a reflection signal reflected by the ground in response to the transmission signal generated by the first sensor in accordance with a control signal (S1302).

The vehicle velocity corrector 100 corrects an ego-vehicle speed detected by the second sensor on the basis of the relative angle and the relative velocity of a reflection signal from the vehicle 10 (S1304).

The flowcharts are described to sequentially perform the processes in the specification, but these are provided only to exemplarily describe the spirit of some embodiments of the present disclosure. In other words, the present disclosure may be changed and modified in various ways by those skilled in the art including some embodiments of the present disclosure by changing the processes described in the flowcharts of the present disclosure or performing one or more of the processes in parallel without departing from the fundamental characteristics of some embodiments of the present disclosure, so the flowcharts of the present disclosure are not limited to a time-series sequence.

Various embodiments such as a device and a method described herein may be implemented by a digital electronic circuit, an integrated circuit, a field programmable gate array (FPGA), an application specific integrated circuit (ASIC), computer hardware, firmware, software, and/or a combination thereof. These various embodiments may include the case in which they are implemented as one or more computer programs that can be executed in a computer-programmable system. The programmable system includes at least one programmable processor (which may be a processor for a specific purpose or a common processor) that is connected to receive data and instructions from a storage system, at least one input device, and at least one output device and transmit data and instructions to them. Computer programs (which have known as programs, software, software applications, or codes) include instructions for a programmable processor and are stored in a “computer-readable recording medium”.

A computer-readable recording medium includes all kinds of recording devices that keep data that can be read by a computer system. The computer-readable recording medium may further include a non-volatile or non-transitory medium such as a ROM, a CD-ROM, a magnetic tape, a floppy disk, a memory card, a hard disk, a magneto-optical disc, and a storage device, or a transitory medium such as a data transmission medium. Further, the computer-readable recording mediums may be distributed to computer systems that are connected through a network and may keep and execute codes that can be divisionally read by computers.

Various embodiments of apparatuses and methods described herein may be implemented by a programmable computer. The computer is a computer-programmable processor, a data storage system (including a volatile memory, a nonvolatile memory, or other types of storage systems, or a combination thereof), and at least one communication interface. For example, the programmable computer may be one of a server, a network device, a set-top box, a built-in device, a computer expansion module, a personal computer, a laptop, a Personal Data Assistant (PDA), a cloud computing system, or a mobile device.

According to an embodiment, there is an effect that ego-vehicle speed correction that is independent from and strong against an external environment such as an error of the physical mounting angle of a radar is performed.

According to another embodiment, there is an effect that an ego-vehicle speed is corrected in real time without a delay even in an environment in which a stationary target is not detected, and an ego-vehicle speed is corrected by a constant calculation time regardless of the number of stationary targets.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the embodiments of the present disclosure is not limited by the illustrations. Accordingly, one of ordinary skill would understand the scope of the claimed invention is not to be limited by the above explicitly described embodiments but by the claims and equivalents thereof

What is claimed is:

1. A method for vehicle velocity correction that is performed by an apparatus for vehicle velocity correction, the method comprising:
a process of calculating a relative velocity of a stationary target detected by a first sensor included in a vehicle, and a relative angle between a driving direction of the vehicle and a direction in which the stationary target is positioned;
a process of creating statistical data about a relative velocity ratio for a plurality of stationary targets based on the relative velocity ratio between a relative velocity of the stationary target and an ego-vehicle speed detected by a second sensor included in the vehicle; and
a process of correcting the ego-vehicle speed detected by the second sensor based on a velocity ratio corresponding to a peak on the statistical data.

2. The method of claim 1, wherein the statistical data are a histogram in which velocity ratios of stationary targets are accumulated in the process of creating.

3. The method of claim 1, wherein the process of correcting includes a process of calculating a corrected ego-vehicle speed by multiplying a reciprocal of the velocity ratio corresponding to the peak by the ego-vehicle speed detected by the second sensor.

4. The method of claim 1, further comprising:
a process of calculating an accumulated difference of accumulated ego-vehicle speed correction values when ego-vehicle speed correction values are accumulated by a preset number of times of correction or more; and
a process of determining an average of the accumulated ego-vehicle speed correction values as a final accumulated ego-vehicle speed correction value when the calculated accumulated difference is less than a preset reference difference.

5. The method of claim 1, further comprising
a process of transmitting a control signal for controlling a range of a transmission signal, which is transmitted from the first sensor, to the first sensor;
a process of calculating a relative angle and a relative velocity of a reflection signal reflected by a ground in response to the transmission signal generated by the first sensor in accordance with the control signal; and
a process of correcting the ego-vehicle speed detected by the second sensor based on the relative angle and the relative velocity.

6. The method of claim 5, wherein in the process of transmitting a control signal to the first sensor, the control signal is a control signal making the first sensor generate an additional transmission signal in a side-lobe type toward the ground or a control signal making the first sensor generate a transmission signal having an expanded range toward the ground.

7. An apparatus for vehicle velocity correction, the apparatus comprising:
a calculator calculating a relative velocity of a stationary target detected by a first sensor included in a vehicle, and a relative angle between a driving direction of the vehicle and a direction in which the stationary target is positioned;
a statistics processor creating statistical data about a relative velocity ratio for a plurality of stationary targets based on the relative velocity ratio between a relative velocity of the stationary target and an ego-vehicle speed detected by a second sensor included in the vehicle; and
a vehicle speed corrector correcting the ego-vehicle speed detected by the second sensor based on a velocity ratio corresponding to a peak on the statistical data.

8. The apparatus of claim 7, wherein the statistical data created by the statistics processor are a histogram in which velocity ratios of stationary targets are accumulated.

9. The apparatus of claim 7, wherein the vehicle speed corrector calculates a corrected ego-vehicle speed by multiplying a reciprocal of the velocity ratio corresponding to the peak by the ego-vehicle speed detected by the second sensor.

10. The apparatus of claim 7, wherein the calculator calculates an accumulated difference of accumulated ego-vehicle speed correction values when ego-vehicle speed correction values are accumulated by a preset number of times of correction or more, and
the vehicle speed corrector determines an average of the accumulated ego-vehicle speed correction values as a final accumulated ego-vehicle speed correction value when the calculated accumulated difference is less than a preset reference difference.

11. The apparatus of claim 7, further comprising
a controller transmitting a control signal for controlling a range of a transmission signal, which is transmitted from the first sensor, to the first sensor,
wherein the calculator calculates a relative angle and a relative velocity of a reflection signal reflected by a ground in response to the transmission signal generated by the first sensor in accordance with the control signal, and
the vehicle speed corrector corrects the ego-vehicle speed detected by the second sensor based on the relative angle and the relative velocity.

12. The apparatus of claim 11, wherein the control signal that is transmitted by the controller is a control signal making the first sensor generate an additional transmission signal in a side-lobe type toward the ground or a control signal making the first sensor generate a transmission signal having an expanded range toward the ground.

13. A vehicle comprising: an apparatus for vehicle velocity correction, the apparatus for vehicle velocity correction comprising:
a calculator calculating a relative velocity of a stationary target detected by a first sensor included in a vehicle, and a relative angle between a driving direction of the vehicle and a direction in which the stationary target is positioned;
a statistics processor creating statistical data about a relative velocity ratio for a plurality of stationary targets based on the velocity ratio between a relative velocity of the stationary target and an ego-vehicle speed detected by a second sensor included in the vehicle; and
a vehicle speed corrector correcting the ego-vehicle speed detected by the second sensor based on a velocity ratio corresponding to a peak on the statistical data.

14. The vehicle of claim 13, wherein the statistical data created by the statistics processor are a histogram in which velocity ratios of stationary targets are accumulated.

15. The vehicle of claim 13, wherein the vehicle speed corrector calculates a corrected ego-vehicle speed by multiplying a reciprocal of the velocity ratio corresponding to the peak by the ego-vehicle speed detected by the second sensor.

16. The vehicle of claim 13, wherein:
the calculator calculates an accumulated difference of accumulated ego-vehicle speed correction values when ego-vehicle speed correction values are accumulated by a preset number of times of correction or more, and
the vehicle speed corrector determines an average of the accumulated ego-vehicle speed correction values as a final accumulated ego-vehicle speed correction value when the calculated accumulated difference is less than a preset reference difference.

17. The vehicle of claim 13, wherein the apparatus for vehicle velocity correction further comprises:
a controller transmitting a control signal for controlling a range of a transmission signal, which is transmitted from the first sensor, to the first sensor,
wherein the calculator calculates a relative angle and a relative velocity of a reflection signal reflected by a ground in response to the transmission signal generated by the first sensor in accordance with the control signal, and
the vehicle speed corrector corrects the ego-vehicle speed detected by the second sensor based on the relative angle and the relative velocity.

18. The vehicle of claim 17, wherein the control signal that is transmitted by the controller is a control signal making the first sensor generate an additional transmission signal in a side-lobe type toward the ground or a control signal making the first sensor generate a transmission signal having an expanded range toward the ground.
